(19) United States
(12) Patent Application Publication
(10) Pub. No.: US 2013/0308922 A1
(43) Pub. Date: Nov. 21, 2013

(54) ENHANCED VIDEO DISCOVERY AND PRODUCTIVITY THROUGH ACCESSIBILITY

(71) Applicants: Christopher Sano, Seattle, WA (US); Ada Cole, Snohomish, WA (US)

(72) Inventors: Christopher Sano, Seattle, WA (US); Ada Cole, Snohomish, WA (US)

(73) Assignee: MICROSOFT CORPORATION, Redmond, WA (US)

(21) Appl. No.: 13/472,208

(22) Filed: May 15, 2012

(51) Int. Cl. H04N 5/92; H04N 21/482

(52) U.S. Cl. 386/245; 725/37; 386/E05.009

(57) ABSTRACT

Methods, systems, and computer program products are provided for enabling the content of a video to be accessed and searched. A textual transcript of audio associated with a video is displayed along with the video. The textual transcript may be displayed in the form of a series of textual captions or in other form. The textual transcript is enabled to be searched according to search criteria. Portions of the transcript that match the search criteria may be highlighted, enabling those portions of the transcript to be accessed and viewed relatively quickly. Locations/play times in the video corresponding to the portions of the transcript that match the search criteria may also be indicated, enabling rapid navigation to those locations/play times.

### BACKGROUND

A video is a stream of images that may be displayed to users to view entities in motion. A video may contain audio to be played when the image stream is being displayed. A video, including video data and audio data, may be stored in a video file in various forms. Examples of video file formats that store compressed video/audio data include MPEG (e.g., MPEG-2, MPEG-4), 3GP, ASF (advanced systems format), AVI (audio video interleaved), Flash Video, etc. Videos may be displayed by various devices, including computing devices and televisions that display the video based on video data stored in a storage medium (e.g., a digital video disc (DVD), a hard disk drive, a digital video recorder (DVR), etc.) or received over a network.

Closed captions may be displayed for videos to show a textual transcription of speech included in the audio portion of the video as it occurs. Closed captions may be displayed for various reasons, including to aid persons that are hearing impaired, to aid persons learning to read, to aid persons learning to speak a non-native language, to aid persons in an environment where the audio is difficult to hear or is intentionally muted, and to be used by persons who simply wish to read a transcript along with the program audio. Such closed captions, however, provide little other functionality with respect to a video being played.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems, and computer program products are provided for enabling the content of a video to be accessed and searched. A textual transcript of audio associated with a video is displayed along with the video. For instance, the textual transcript may be displayed in the form of a series of textual captions (closed captions) or in other form. The textual transcript is enabled to be searched according to search criteria. Portions of the transcript that match the search criteria may be highlighted, enabling those portions of the transcript to be accessed and viewed relatively quickly. Locations/play times in the video corresponding to the portions of the transcript that match the search criteria may also be indicated, enabling rapid navigation to those locations/play times.

In one method implementation, a user interface is generated to display at a computing device. A video display region of the user interface is generated that displays a video. A transcript display region of the user interface is generated that displays at least a portion of a transcript. The transcript includes one or more textual captions of audio associated with the video. A search interface is generated to display in the user interface, and is configured to receive one or more search terms from a user to be applied to the transcript.

As such, one or more search terms may be provided to the search interface by a user. One or more textual captions of the transcript that include the search term(s) are determined. One or more indications are generated to display in the transcript display region that indicate the determined textual captions that include the search term(s).

Still further, a graphical feature may be generated to display in the user interface having a length that corresponds to a time duration of the video. One or more indications may be generated to display at positions on the graphical feature to indicate times of occurrence of audio corresponding to textual caption(s) determined to include the search term(s).

Still further, a graphical feature may be generated to display in the user interface having a length that corresponds to a length of the transcript. One or more indications may be generated to display at positions on the graphical feature that indicate positions of occurrence in the transcript of textual caption(s) determined to include the search term(s).

Still further, a user may be enabled to interact with a textual caption displayed in the transcript display region to provide an edit to text of the textual caption and/or to annotate the textual caption. Furthermore, a user interface element may be displayed that enables a user to select a language from a plurality of languages for text of the transcript to be displayed in the transcript display region.

In another implementation, a video searching media player system is provided. The video searching media player system includes a media player, a transcript display module, and a search interface module. The media player plays a video in a video display region of a user interface. The video is included in a media object that further includes a transcript of audio associated with the video. The transcript includes a plurality of textual captions. The transcript display module displays at least a portion of the transcript in a transcript display region of the user interface. The displayed transcript includes at least one of the textual captions. The search interface module generates a search interface displayed in the user interface that is configured to receive one or more search terms from a user to be applied to the transcript.

The system may further include a search module. The search module determines one or more textual captions of the transcript that match the received search terms. The transcript display module generates one or more indications to display in the transcript display region that indicate the determined textual caption(s) that include the search term(s).

Computer program products containing computer readable storage media are also described herein that store computer code/instructions for enabling the content of videos to be searched, as well as enabling additional embodiments described herein.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows a block diagram of a user interface for a playing a video, displaying a transcript of the video, and enabling a search of the transcript, according to an example embodiment.

FIG. 2 shows a block diagram of a system that generates a transcript of a video, according to an example embodiment.

FIG. 3 shows a block diagram of a communications environment in which a media object is delivered to a computing device having a video searching media player system, according to an example embodiment.

FIG. 4 shows a block diagram of a computing device that includes a video searching media player system, according to an example embodiment.

FIG. 5 shows a flowchart providing a process for generating a user interface that displays a video, displays a transcript, and provides a transcript search interface, according to an example embodiment.

FIG. 6 shows a block diagram of a video searching media player system, according to an example embodiment.

FIG. 7 shows a flowchart providing a process for highlighting textual captions of a transcript of a video to indicate search results, according to an example embodiment.

FIG. 8 shows a block diagram of an example of the user interface of FIG. 1, according to an embodiment.

FIG. 9 shows a flowchart providing a process for indicating play times of search results in a video, according to an example embodiment.

FIG. 10 shows a flowchart providing a process for indicating locations of search results in a transcript of a video, according to an example embodiment.

FIG. 11 shows a process that enables a user to edit a textual caption of a transcript of a video, according to an example embodiment.

FIG. 12 shows a process that enables a user to select a language of a transcript of a video, according to an example embodiment.

FIG. 13 shows a block diagram of an example computer that may be used to implement embodiments of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” “upper,” “lower,” etc.) used herein are for purposes of illustration only, and that practical implementations of the structures described herein can be spatially arranged in any orientation or manner.

Numerous exemplary embodiments of the present invention are described as follows. It is noted that any section/subsection headings provided herein are not intended to be limiting. Embodiments are described throughout this document, and any type of embodiment may be included under any section/subsection.

### II. Example Embodiments

Consumers of videos face challenges with respect to the videos, especially technical videos. For instance, how does a user know whether information desired by the user (e.g., an answer to a question, etc.) is included in the information provided by a video? Furthermore, if the desired information is included in the video, how does the user navigate directly to the information? Still further, if the voice audio of a video is not in a language that is familiar to the user, how can the user even use the video? Video content is locked into a timeline of the video, so even if a user believes the information that they desire is included in the video, the user has to guess where the content is in time in the video, and manually advance the video to the guessed location. Due to these deficiencies of videos, content publishers suffer from low return on investment (ROI) on their video content because search engines can only access limited metadata associated with the video (e.g., a record time and date for the video, etc.).

Embodiments overcome these deficiencies of videos, enabling users and search engines to quickly and confidently view, search, and share the content contained in videos. According to embodiments, a user interface is provided that enables a textual transcript of audio associated with a video to be searched according to search criteria. Text in the transcript that matches the search criteria may be highlighted, enabling the text to be accessed quickly. Furthermore, locations in the video corresponding to the text matching the search criteria may be indicated, enabling rapid navigation to those locations in the video. As such, users are enabled to rapidly find information located in a video by searching through the transcript of the audio content.

Embodiments provide content publishers with benefits, including improved crawling and indexing of their content, which can improve content ROI through discoverability. Search, navigation, community, and social features are provided that can be applied to a video through the power of captions.

Embodiments enable various features, including time-stamped search relevancy, tools that enhance discovery of content within videos, aggregation of related content based on video content, deep linking to other content, and multiple layers of additional metadata that drive a rich user experience.

As described above, in embodiments, users may be enabled to search the content of videos, such as by interacting with a user interface. Such a user interface may be implemented in various ways. For instance, FIG. 1 shows a block diagram of a user interface 102 for a playing a video, displaying a transcript of the video, and enabling a search of the transcript, according to an example embodiment. As shown in FIG. 1, user interface 102 includes a video display region 104, a transcript display region 106, and a search interface 108. User interface 102 and its features are described as follows.

User interface 102 may be displayed by a display screen associated with a device. As shown in FIG. 1, video display region 104 displays a video 110 that is being played. In other words, a stream of images of a video is displayed in video display region 104 as video 110. Transcript display region 106 displays a transcript 112, which is a textual transcript of audio associated with video 110. For instance, transcript 112 may include one or more textual captions of the audio associated with video 110, such as a first textual caption 114a, a second textual caption 114b, and optionally further textual captions (e.g., closed captions). Each textual caption may correspond to a full spoken sentence, or a portion of a spoken sentence. Depending on the length of transcript 112, all of transcript 112 may be visible in transcript display region 106 at any particular time, or a portion of transcript 112 may be visible in transcript display region 106 (e.g., a subset of the textual captions of transcript 112). During normal operation, when video 110 is playing in video display region 104, a textual caption of transcript 112 may be displayed in transcript display region 106 that corresponds to the audio of video 110 that is concurrently/synchronously playing. For instance, the textual caption of currently playing audio may be displayed at the top of transcript display region 106, and may automatically scroll downward (e.g., in a list of textual captions) when a next textual caption is displayed that corresponds to the next currently playing audio. The textual caption corresponding to currently playing audio may also optionally be displayed in video display region 104 over a portion of video 110.

Search interface 108 is displayed in user interface 102, and is configured to receive one or more search terms (search keywords) from a user to be applied to transcript 112. For instance, a user that is interacting with user interface 102 may type or otherwise enter search criteria that includes one or more search terms into a user interface element of search interface 108 to have transcript 112 accordingly searched. Simple word searches may be performed, such that the user may enter one or more words into search interface 102, and those one or more words are searched for in transcript 112 to generate search results. Alternatively, more complex searches may be performed, such that the user may enter one or more words as well as one or more search operators (e.g., Boolean operators such as “OR”, “AND”, “ANDNOT”, etc.) to form a search expression (that may or may not be nested) that is applied to transcript 112 to generate search results. As described in further detail below, the search results may be indicated in transcript 112, such as by highlighting specific text and/or specific textual captions that match the search criteria.

Search interface 108 may have any form suitable to enable a user to provide search criteria. For instance, search interface 108 may include one or more of any type of suitable graphical user interface element, such as a text entry box, a button, a pull down menu, a pop-up menu, a radio button, etc. to enable search criteria to be provided, and a corresponding search to be executed. A user may interact with search interface 108 in any manner, including a keyboard, a thumb wheel, a pointing device, a roller ball, a stick pointer, a touch sensitive display, any number of virtual interface elements, a voice recognition system, etc.

User interface 102 may be a user interface generated by any type of application, including a web browser, a desktop application, a mobile “app” or other mobile device application, and/or any other application. For instance, in a web browser example, user interface 102 may be shown on a web page, and video display region 104, transcript display region 106, and search interface 108 may each be portions of the web page (e.g., panels, frames, etc.). In the example of FIG. 1, video display region 104 is positioned in a left side of user interface 102, transcript display region 106 is shown positioned in a bottom-right side of user interface 102, and search interface 108 is shown positioned in a top-right side of user interface 102. This arrangement of video display region 104, transcript display region 106, and search interface 108 in user interface 102 is provided for purposes of illustration, and is not intended to be limiting. In further embodiments, video display region 104, transcript display region 106, and search interface 108 may be positioned and sized in user interface 108 in any manner, as desired for a particular application.

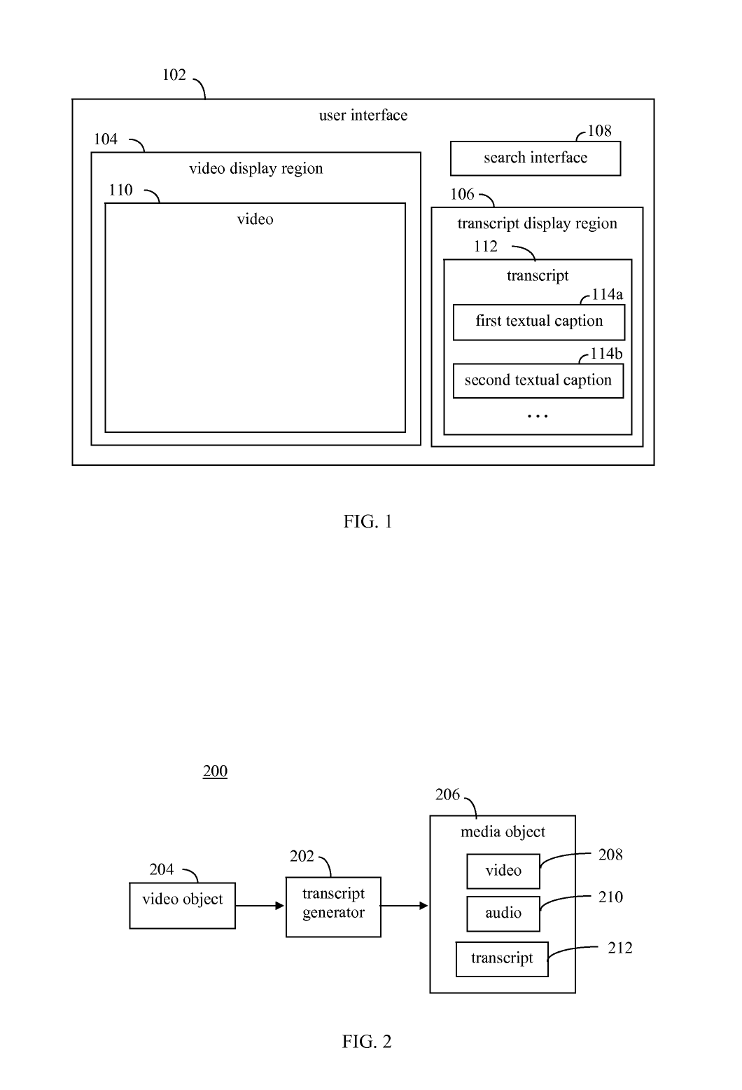

Transcript 112 may be generated in any manner, including being generated offline (e.g., prior to playing of video 110 to a user) or in real-time (e.g., during play of video 110 to a user). FIG. 2 shows a block diagram of a transcript generation system 200 that generates a transcript of a video, according to an example embodiment. As shown in FIG. 2, system 200 includes a transcript generator 202 that receives a video object 204. Video object 204 is formed of one or more files that contain a video and audio associated with the video. Examples of compressed video file formats for video object 204 include MPEG (e.g., MPEG-2, MPEG-4), 3GP, ASF (advanced systems format) (which may encapsulate video in WMV (Windows Media Video) format and audio in WMA (Windows Media Audio) format), AVI (audio video interleaved), Flash Video, etc. Transcript generator 202 receives video object 204, and generates a transcript of the audio of video object 204. For instance, as shown in FIG. 2, transcript generator 202 may generate a media object 206 that includes video 208, audio 210, and a transcript 212. Video 208 is the video of video object 204, audio 210 is the audio of video object 204, and transcript 212 is a textual transcription of the audio of video object 204. Transcript 212 is an example of transcript 112 of FIG. 1, and may include the audio of video object 204 in the form of text in any manner, including as a list of textual captions. Transcript generator 202 may generate media object 206 in any form, including according to file formats such as MPEG, 3GP, ASF, AVI, Flash Video, etc.

Transcript generator 202 may generate media object 206 in any manner, including according to commercially available or proprietary transcription techniques. For instance, in an embodiment, transcript generator 202 may implement a speech-to-text translator and/or speech recognition techniques to generate transcript 212 from audio of video object 204. In embodiments, transcript generator 202 may implement speech recognition based on Hidden Markov Models, dynamic time warping, and/or neural networks. In one embodiment, transcript generator 202 may implement the Microsoft® Research Audio Video Indexing System (MAVIS), developed by Microsoft Corporation of Redmond, Wash. MAVIS includes a set of software components that use speech recognition technology to recognize speech, and thereby can be used to generate transcript 212 to include a series of closed captions. In an embodiment, confidence ratings may also be generated (e.g., by MAVIS, or by other technique) that indicate a confidence in an accuracy of a translation of speech-to-text by transcript generator 202. A confidence rating may be generated for and associated with each textual caption or other portion of transcript 212, for instance. A confidence rating may or may not be displayed with the corresponding textual caption in transcript display region 106, depending on the particular implementation.

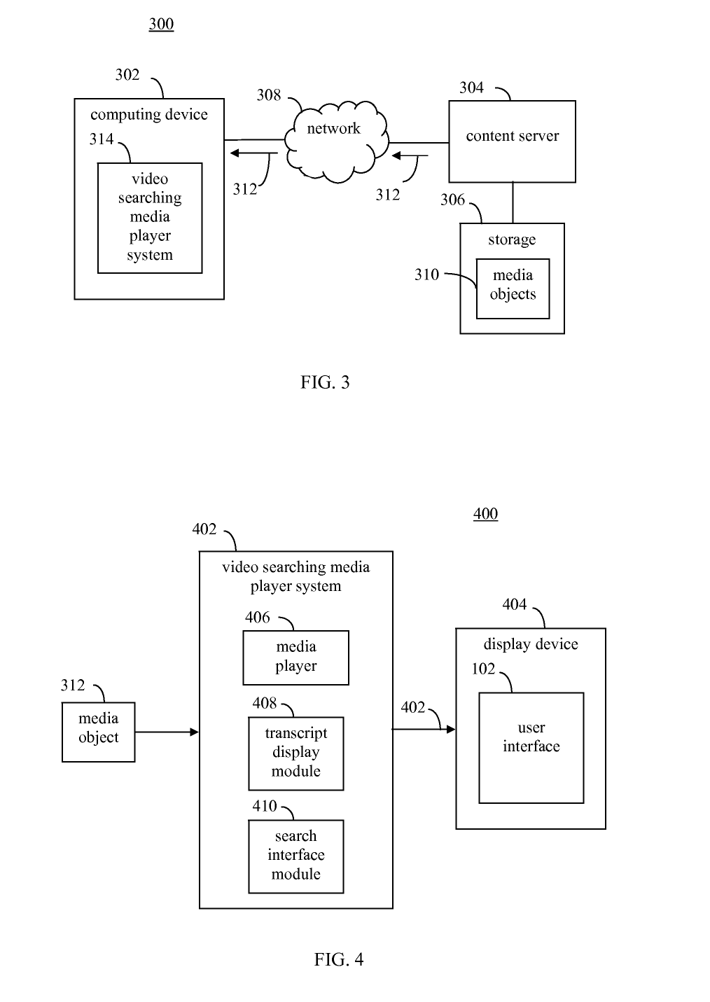

Media objects that include video, audio, and audio transcripts may be received at devices for playing and searching in any manner For instance, FIG. 3 shows a block diagram of a communications environment 300 in which a media object 312 is delivered to a computing device 302 having a video searching media player system 314, according to an example embodiment. As shown in FIG. 1, environment 300 includes computing device 302, a content server 304, storage 306, and a network 308. Environment 100 is provided as an example embodiment, and embodiments may be implemented in alternative environments. Environment 100 is described as follows.

Content server 304 is configured to serve content to user computers, and may be any type of computing device capable of serving content. Computing device 302 may be any type of stationary or mobile computing device, including a desktop computer (e.g., a personal computer, etc.), a mobile computer or computing device (e.g., a Palm® device, a RIM Blackberry® device, a personal digital assistant (PDA), a laptop computer, a notebook computer, a tablet computer (e.g., an Apple iPad™), a netbook, etc.), a mobile phone (e.g., a cell phone, a smart phone such as an Apple iPhone, a Google Android™ phone, a Microsoft Windows® phone, etc.), or other type of stationary or mobile device.

A single content server 304 and a single computing device 302 are shown in FIG. 3 for purposes of illustration. However, any number of computing devices 302 and content servers 304 may be present in environment 300, including tens, hundreds, thousands, and even greater numbers of computing devices 302 and/or content servers 304.

Computing device 302 and content server 304 are communicatively coupled by network 308. Network 308 may include one or more communication links and/or communication networks, such as a PAN (personal area network), a LAN (local area network), a WAN (wide area network), or a combination of networks, such as the Internet. Computing device 302 and content server 304 may be communicatively coupled to network 308 using various links, including wired and/or wireless links, such as IEEE 802.11 wireless LAN (WLAN) wireless links, Worldwide Interoperability for Microwave Access (Wi-MAX) links, cellular network links, wireless personal area network (PAN) links (e.g., Bluetooth™ links), Ethernet links, USB links, etc.

As shown in FIG. 3, storage 306 is coupled to content server 304. Storage 306 stores any number of media objects 310. At least some of media objects 310 may be similar to media object 206, including video, associated audio, and an associated textual transcript of the audio. Content server 304 may access storage 306 for media objects 310 to transmit to computing devices in response to requests.

For instance, in an embodiment, computing device 302 may transmit a request (not shown in FIG. 3) through network 308 to content server 304 for a media object. A user of computing device 302 may desire to play and/or interact with the media object using video searching media player system 314. In response, content server 304 may access the media object identified in the request from storage 306, and may transmit the media object to computing device 302 through network 308 as media object 312. As shown in FIG. 3, computing device 302 receives media object 312, which may be provided to video searching media player system 314. Media object 312 may be transmitted by content server 304 according to any suitable communication protocol, such as TCP/IP (Transmission Control Protocol/Internet Protocol), User Datagram Protocol (UDP), etc., and according to any suitable file transfer protocol, such as FTP (File Transfer Protocol), HTTP (Hypertext Transfer Protocol), etc.

Video searching media player system 314 is capable of playing a video of media object 312, playing the associated audio, and displaying the transcript of media object 312. Furthermore, video searching media player system 314 provides search capability for searching the transcript of media object 312. For instance, in an embodiment, video searching media player system 314 may generate a user interface similar to user interface 102 of FIG. 1 to enable searching of video content.

Video searching media player system 314 may be configured in various ways to perform its functions. For instance, FIG. 4 shows a block diagram of a computing device 400 that enables searching of video content, according to an example embodiment. As shown in FIG. 4, computing device 400 includes a video searching media player system 402 and a display device 404. Furthermore, video searching media player system 402 includes a media player 406, a transcript display module 408, and a search interface module 410. Video searching media player system 402 is an example of video searching media player system 314 of FIG. 3, and computing device 400 is an example of computing device 302 of FIG. 3.

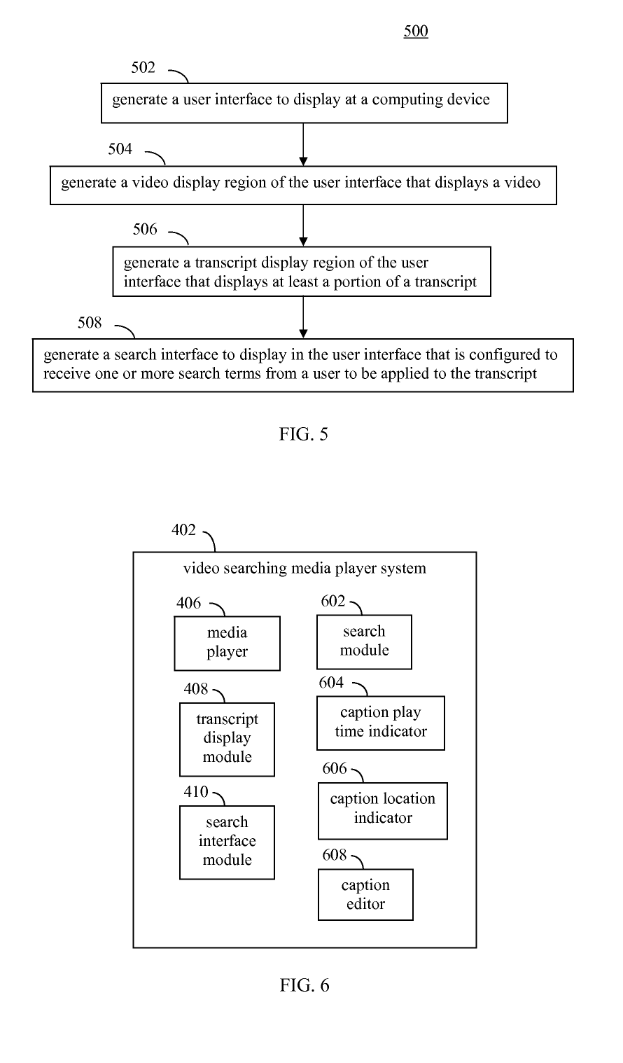

As shown in FIG. 4, video searching media player system 402 receives media object 312. Video searching media player system 402 is configured to generate user interface 102 to display a video of media object 312, to view a transcript of audio associated with the displayed video, and to search the transcript for information. Video searching media player system 402 is further described as follows with respect to FIG. 5. FIG. 5 shows a flowchart 500 providing a process for generating a user interface that displays a video, displays a transcript, and provides a transcript search interface, according to an example embodiment. In an embodiment, video searching media player system 402 may operate according to flowchart 500. Video searching media player system 402 and flowchart 500 are described as follows. Further structural and operational embodiments will be apparent to persons skilled in the relevant art(s) based on the following description of video searching media player system 402 and flowchart 500.

Flowchart 500 begins with step 502. In step 502, a user interface is displayed at a computing device. As described above, in an embodiment, video searching media player system 402 may generate user interface 102 to be displayed by display device 404. Display device 404 may include any suitable type of display, such as a cathode ray tube (CRT) display (e.g., in the case where computing device 400 is a desktop computer), a liquid crystal display (LCD) display, a light emitting diode (LED) display, a plasma display, or other display type. User interface 102 enables a video of media object 312 to be played, displays a textual transcript of the playing video, and enables the transcript to be searched. Steps 504, 506, and 508 further describe these features of step 502 (and therefore steps 504, 506, and 508 may be considered to be processes performed during step 502 of flowchart 500, in an embodiment).

In step 504, a video display region of the user interface is generated that displays a video. For instance, in an embodiment, media player 406 may play video 110 (of media object 312) in a region designated as video display region 104 of user interface 102. Media player 406 may be configured in any suitable manner to play video 110. For instance, media player 406 may include a proprietary video player or a commercially available video player, such as Windows Media Player developed by Microsoft Corporation of Redmond, Wash., QuickTime® developed by Apple Inc. of Cupertino, Calif., etc. Media player 406 may also play the audio associated with video 110 synchronously with video 110.

In step 506, a transcript display region of the user interface is generated that displays at least a portion of a transcript. For instance, in an embodiment, transcript display module 408 may display all or a portion of transcript 112 (of media object 312) in a region designated as transcript display region 106 of user interface 102. Transcript display module 408 may be configured in any suitable manner to display transcript 112. For instance, transcript display module 408 may include a proprietary or commercially available module configured to display scrollable text.

In step 508, a search interface is generated that is displayed in the user interface, and that is configured to receive one or more search terms from a user to be applied to the transcript. For example, in an embodiment, search interface module 410 may generate search interface 108 to be displayed in user interface 102. As described above, search interface 108 is configured to receive one or more search terms and/or other search criteria from a user to be applied to transcript 112. Search interface module 410 may be configured in any suitable manner to generate search interface 108 for display, including using user interface elements that are included in commercially available operating systems and/or browsers, and/or according to other techniques.

In this manner, a user interface may be generated for playing a selected video, displaying a transcript associated with the selected video, and displaying a search interface for searching the transcript. The above example embodiments of user interface 102, video searching media player system 314, video searching media player system 402, and flowchart 500 are provided for illustrative purposes, and are not intended to be limiting. User interfaces for accessing video content, methods for generating such user interfaces, and video searching media player systems may be implemented in other ways, as would be apparent to persons skilled in the relevant art(s) from the teachings herein.

It is noted that as shown in FIG. 4, video searching media player system 402 may be included in computing device 400 that is accessed locally by a user. In other embodiments, one or more of the components of video searching media player system 402 may be located remotely from computing device 400 (e.g., in content server 304), such as in a cloud-based implementation.

In embodiments, video searching media player system 402 may be configured with further functionality, including search capability, caption editing capability, and techniques for indicating the locations of search terms in videos. For instance, FIG. 6 shows a block diagram of video searching media player system 402, according to an example embodiment. As shown in FIG. 6, video searching media player system 402 includes media player 406, transcript display module 408, search interface module 410, a search module 602, a caption play time indicator 604, a caption location indicator 606, and a caption editor 608. The elements of video searching media player system 402 shown in FIG. 6 are described as follows.

Search module 602 is configured apply the search criteria received at search interface 108 (FIG. 1) from a user to transcript 112 to determine search results. Search module 602 may be configured in various ways to apply search criteria to transcript 112 to generate search results. In embodiments, simple word searches may be performed by search module 602. For instance, in an embodiment, search module 602 may determine one or more textual captions of transcript 112 that include one or more search terms that are provided by the user to search interface 108. The determined one or more textual captions may be provided as search results.

Alternatively, even more complex searches may be performed by search module 602. For instance, a user may enter search operators (e.g., Boolean operators such as “OR”, “AND”, “ANDNOT”, etc.) in addition to search terms to form a search expression that may applied to transcript 112 by search module 602 to generate search results. In still further embodiments, search module 602 may index transcript 112 in a similar manner to a search engine indexing a document. In this manner, the media object (e.g., video) that is associated with transcript 112 may show up in search results for searches performed by a search engine. In such an embodiment, search module 602 may include a search engine that indexes a plurality of documents (e.g., documents of the World Wide Web) including transcript 112.

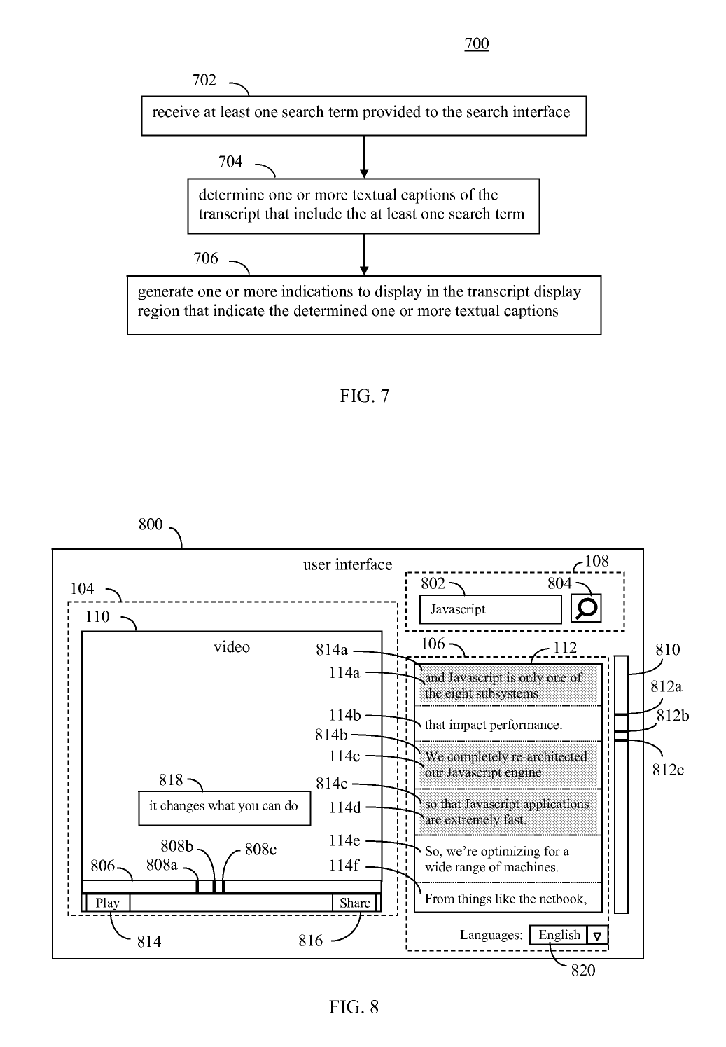

In an embodiment, search module 602 may operate according to FIG. 7. FIG. 7 shows a flowchart 700 providing a process for highlighting textual captions of a transcript of a video that includes search results, according to an example embodiment. In an embodiment, search module 602 may perform flowchart 700. Search module 602 and flowchart 700 are described as follows. Further structural and operational embodiments will be apparent to persons skilled in the relevant art(s) based on the following description of flowchart 700.

Flowchart 700 begins with step 702. In step 702, at least one search term provided to the search interface is received. For instance, as described above, a user may input one or more search terms to search interface 108. For example, the user may type in the words “red corvette,” or other search terms of interest.

In step 704, one or more textual captions of the transcript is/are determined that include the at least one search term. Referring to FIG. 6, in an embodiment, search module 602 may receive the search term(s) from search interface module 410. Search module 602 may search through the transcript displayed by transcript display module 408 for any occurrences of the search term(s), and may generate search results that indicate the occurrences of the search term(s). Search module 602 may indicate the location(s) in the transcript of the search term(s) in any manner, including by timestamp, word-by-word, by textual caption (e.g., where each textual caption has an associated identifier), by sentence, by paragraph, and/or in another manner Furthermore, search module 602 may indicate the play time in video 110 in which the search term is found by the play time (timestamp) of the corresponding word, textual caption, sentence, paragraph, etc., in video 110. Search module 602 may store the determined locations and play times for each search result in storage associated with video searching media player system 402 (e.g., memory, etc.), as described elsewhere herein.

In step 706, one or more indications are generated to display in the transcript display region that indicate the determined one or more textual captions. Referring to FIG. 6, in an embodiment, search module 602 may provide the search results to transcript display module 408. Transcript display module 408 may receive the search results, and may generate one or more indications for display in transcript display region 106 to display the search results. For instance, in embodiments, transcript display module 408 may show each occurrence of the search term(s), and/or may highlight the sentence, textual caption, paragraph, and/or other transcript portion that includes one or more occurrence of the search term(s). Transcript display module 408 may indicate the search results in transcript display region 106 in any manner, including by applying an effect to transcript 112 such as bold text, italicized text, a color of text, a size of text, highlighting a block of text such as a sentence, a textual caption, a paragraph, etc. (e.g., by showing the text in a rectangular or other shaped shaded/colored block, etc.), and/or using any other technique to highlight the search results in transcript 112.

For example, FIG. 8 shows a block diagram of a user interface 800, according to an embodiment. User interface 800 is an example of user interface 102 of FIG. 1. As shown in FIG. 8, user interface 800 includes video display region 104, transcript display region 106, and search interface 108. Video display region 104 displays a video 110 that is being played. As shown in FIG. 8, video display region 104 may include one or more user interface controls, such as a “play” button 814 and/or other user interface elements (e.g., a pause button, a fast forward button, a rewind button, a stop button, etc.) that may be used to control the playing of video 110. Furthermore, video display region 104 may display a textual caption 818 (e.g., overlaid on video 110, or elsewhere) that corresponds to audio currently being played synchronously with video 110 (e.g., via one or more speakers). Transcript display region 106 displays an example of transcript 112, where transcript 112 includes first-sixth textual captions 114a-114f. Furthermore, search interface 108 includes a text entry box 802 and a search button 804. According to step 702 of FIG. 7, a user may enter one or more search terms into text entry box 802, and may interact with (e.g., click on, using a mouse, etc.) search button 804 to cause a search of transcript 112 to be performed.

In the example of FIG. 8, a user entered the search term “Javascript” into text entry box 802 and interacted with search button 804 to cause a search of transcript 112 to be performed. As a result, according to step 704 of FIG. 7, search module 602 performs a search of transcript 112 for the search term “Javascript.”

In the example of FIG. 8, three search results were found by search module 602 in transcript 112 for the search term “Javascript.” According to step 706 of FIG. 7, transcript display module 408 has generated rectangular gray boxes to indicate the search results in transcript 112 for the user to see. As shown in FIG. 7, textual caption 114a includes the text “and Javascript is only one of the eight subsystems,” textual caption 114c includes the text “We completely re-architected our Javascript engine,” and textual caption 114d includes the text “so that Javascript applications are extremely fast,” each of which include an occurrence of the word “Javascript.” As such, transcript display module 408 has generated first-third indications 814a-814c as rectangular gray boxes that overlay textual captions 114a, 114c, and 114d, respectively, to indicate that the search term “Javascript” was found in each of textual captions 114a, 114c, and 114d.

As such, a user is enabled to perform a search of a transcript associated with a video, thereby enabling the user to search the contents of the video. As described above, results of the search may be indicated in the transcript, and the user may be enabled to scroll, page, or otherwise move forwards and/or backwards through the transcript to view the search results. In embodiments, further features may be provided to enable the user to more rapidly ascertain a frequency of search terms appearing in the transcript, to determine a location of the search terms in the transcript, and to move to locations of the transcript that include the search terms.

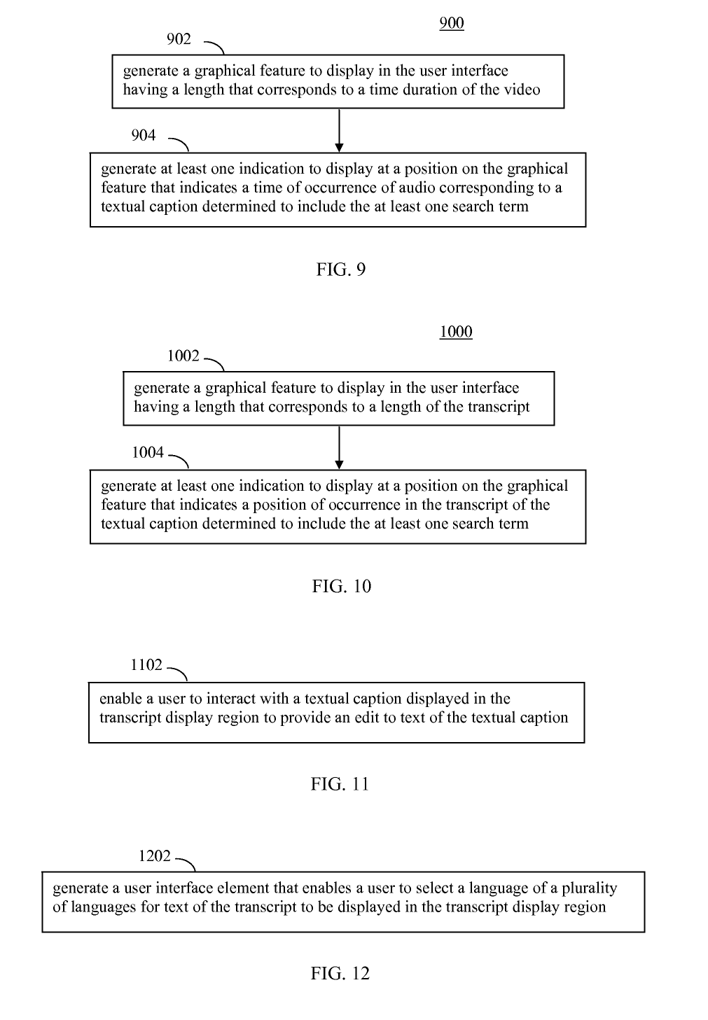

For example, in an embodiment, a user interface element may be displayed that indicates locations of search results in a time line of the video associated with the transcript. For instance, FIG. 9 shows a flowchart 900 providing a process for indicating play times of a video for search results, according to an example embodiment. In an embodiment, flowchart 900 may be performed by caption play time indicator 604. Caption play time indicator 604 and flowchart 900 are described as follows. Further structural and operational embodiments will be apparent to persons skilled in the relevant art(s) based on the following description of caption play time indicator 604 and flowchart 900.

Flowchart 900 begins with step 902. In step 902, a graphical feature is generated to display in the user interface having a length that corresponds to a time duration of the video. For example, FIG. 8 shows a first graphical feature 806 having a rectangular shape, being positioned below video 110 in video display region 104, and having a length that is approximately the same as a width of the displayed video 110 in video display region 104. In an embodiment, the length of first graphical feature 806 corresponds to a time duration of video 110. For instance, if video 110 has a total time duration of 20 minutes, each position along the length of first graphical feature 806 corresponds to a time during the time duration of 20 minutes. The left most position of first graphical feature 806 corresponds to a time zero of video 110, the right most position of first graphical feature 806 corresponds to the 20 minute time of video 110, and each position in between of first graphical feature 806 corresponds to a time of video 110 between zero and 20 minutes, with the time of video 110 increasing when moving from left to right along first graphical feature 806.

In step 904, at least one indication is generated to display at a position on the graphical feature that indicates a time of occurrence of audio corresponding to a textual caption determined to include the at least one search term. In an embodiment, caption play time indicator 604 may receive the play time(s) in video 110 for the search result(s) from search module 602 (or directly from storage). For instance, caption play time indicator 604 may receive a timestamp in video 110 for each textual caption that includes a search term. In an embodiment, caption play time indicator 604 is configured to generate an indication that is displayed on first graphical feature 806 for the search result(s) at each play time. Any type of indication may be displayed on first graphical feature 806, including an arrow, a letter, a number, a symbol, a color, etc., to indicate the play time for a search result. For instance, as shown in FIG. 8, first-third vertical bar indications 808a-808c are shown displayed on first graphical feature 806 to indicate the play times for textual captions 114a, 114c, and 114d, each of which were determined to include the search term “Javascript.”

Thus, first graphical feature 806 indicates the locations/play times in a video corresponding to the portions of a transcript of the video that match search criteria. A user can view the indications displayed on first graphical feature 806 to easily ascertain the locations in the video of matching search terms. In an embodiment, the user may be enabled to interact with first graphical feature 806 to cause the display/playing of video 110 to switch to a location of a matching search term. For instance, the user may be enabled to “click” on an indication displayed on first graphical feature 806 to cause play of video 110 to occur at the location of the indication. In another embodiment, the user may be enabled to “slide” a video play position indicator along first graphical feature 806 to the location of an indication to cause play of video 110 to occur at the location of the indication. In other embodiments, the user may be enabled to cause the display/playing of video 110 to switch to a location of a matching search term in other ways.

For instance, in the example of FIG. 8, the user may be enabled in this manner to cause the display/playing of video 110 to switch to a play time of any of indications 808a, 808b, and 808c (FIG. 8), where a corresponding textual caption of transcript 112 of video 110 contains the search term of “Javascript.”

In another embodiment, a user interface element may be displayed that indicates locations of search results in the transcript. For instance, FIG. 10 shows a flowchart 1000 providing a process for indicating locations of search results in a transcript of a video, according to an example embodiment. In an embodiment, flowchart 1000 may be performed by caption location indicator 606. Caption location indicator 606 and flowchart 1000 are described as follows. Further structural and operational embodiments will be apparent to persons skilled in the relevant art(s) based on the following description of caption location indicator 606 and flowchart 1000.

Flowchart 1000 begins with step 1002. In step 1002, a graphical feature is generated to display in the user interface having a length that corresponds to a length of the transcript. For example, FIG. 8 shows a second graphical feature 810 having a rectangular shape, being positioned adjacent to transcript 112 in transcript display region 106, and having a length that is approximately the same as a height of the displayed portion of transcript 112 in transcript display region 106. In an embodiment, the length of second graphical feature 810 corresponds to a length of transcript 112 (including a portion of transcript 112 that is not displayed in transcript display region 106). For instance, if transcript 112 includes one hundred textual captions, each position along the length of second graphical feature 810 corresponds to a particular textual caption of the one hundred textual captions. A first (e.g., upper most) position of second graphical feature 810 corresponds to a first textual caption of transcript 112, a last (e.g., lower most) position of second graphical feature 810 corresponds to the one hundredth textual caption of transcript 112, and each position in-between of second graphical feature 810 corresponds to a textual transcript of transcript 112 between the first and last textual transcripts, with the number of the textual transcript (in order) in transcript 112 increasing when moving from top to bottom along second graphical feature 810.

In step 1004, at least one indication is generated to display at a position on the graphical feature that indicates a position of occurrence in the transcript of the textual caption determined to include the at least one search term. In an embodiment, caption location indicator 606 may receive the location of the textual captions (e.g., by identifier and/or timestamp) in transcript 112 for the search result(s) from search module 602 (or directly from storage). In an embodiment, caption location indicator 606 is configured to generate an indication that is displayed on second graphical feature 810 at each of the locations. Any type of indication may be displayed on second graphical feature 810, including an arrow, a letter, a number, a symbol, a color, etc., to indicate the location for a search result. For instance, as shown in FIG. 8, first-third horizontal bar indications 812a-812c are shown displayed on second graphical feature 810 to indicate the locations of textual captions 114a, 114c, and 114d, in transcript 112, each of which were determined to include the search term “Javascript.”

Thus, second graphical feature 810 indicates the locations in a transcript that match search criteria. A user can view the indications displayed on second graphical feature 810 to easily ascertain the locations in the transcript of the matching search terms. In an embodiment, the user may be enabled to interact with second graphical feature 810 to cause the display of transcript 112 in transcript display region 106 to switch to a location of a matching search term. For instance, the user may be enabled to “click” on an indication displayed on second graphical feature 810 to cause transcript display region 106 to display the portion of transcript 112 at the location of the indication. In another embodiment, the user may be enabled to “slide” a scroll bar along second graphical feature 810 to overlap the location of an indication to cause the portion of transcript 112 at the location of the indication to be displayed. For instance, one or more textual captions may be displayed, including a textual caption that includes a search term indicated by the indication. In other embodiments, the user may be enabled to cause the display of transcript 112 to switch to a location of a matching search term in other ways.

For instance, in the example of FIG. 8, the user may be enabled in this manner to cause the display of transcript 112 to switch to displaying the textual caption associated with any of indications 812a, 812b, and 812c (FIG. 8).

In another embodiment, users may be enabled to edit textual captions of a transcript. In this manner, the accuracy of the speech-to-text transcription of transcripts may be improved. For instance, FIG. 11 shows a step 1102 that enables a user to edit a textual caption of a transcript of a video, according to an example embodiment. In an embodiment, step 1102 may be performed by caption editor 608.

In step 1102, a user is enabled to interact with a textual caption displayed in the transcript display region to provide an edit to text of the textual caption. In embodiments, caption editor 608 may enable a textual caption to be edited in any manner. For instance, in an embodiment, the user may use a mouse pointer or other mechanism for interacting with a textual caption displayed in transcript display region 106. The user may hover the mouse pointer over a textual caption that the user selects to be edited, such as textual caption 114b shown in FIG. 8, which may cause caption editor 608 to generate an editor interface for editing text of textual caption 114b, or may interact in another suitable way. The user may edit the text of textual caption 114b in any manner, including by deleting text and/or adding new text (e.g., by typing, by voice input, etc.). The user may be enabled to save the edited text by interacting with a “save” button or other user interface element. The edited text may be saved in transcript 112 in place of the previous text, and the previous text is deleted, or the previous text may be saved in an edit history for transcript 112, in embodiments. During subsequent viewings of textual caption 114b in transcript 112, the edited text may be displayed.

In another embodiment, users may be enabled to select a display language for a transcript. In this manner, users that understand various different languages may all be enabled to read textual captions of a displayed transcript. For instance, FIG. 12 shows a step 1202 for enabling a user to select a language of a transcript of a video, according to an example embodiment. In an embodiment, step 1202 may be performed by transcript display module 408.

In step 1202, a user interface element is generated that enables a user to select a language of a plurality of languages for text of the transcript to be displayed in the transcript display region. In embodiments, transcript display module 408 (e.g., a language selector module of transcript display module 408) may generate any suitable type of user interface element described elsewhere herein or otherwise known to enable a language to be selected from a list of languages for transcript 112. For instance, as shown in FIG. 8, transcript display module 408 may generate a user interface element 820 that is a pull down menu. A user may interact with user interface element 820 by clicking on user interface element 820 with a mouse pointer (or in other manner), which causes a pull down list of languages from which the user can select (by mouse pointer) a language in which the text of transcript 112 shall be displayed. For instance, the user may be enabled to select English, Spanish, French, German, Chinese, Japanese, etc., as a display language for transcript 112.

As such, transcript 112 may be stored in a media object in the form of one or multiple languages. Each language version for transcript 112 may be generated by manual or automatic translation. Furthermore, in embodiments, textual edits may be separately received for each language version of transcript 112 (using caption editor 608), or may be received for one language version of transcript 112, and automatically translated to the other language versions of transcript 112.

In another embodiment, a user may be enabled to share a video and the related search information that the user generated by interacting with search interface 108. In this manner, users may be provided with information regarding searches performed on video content by other users in a quick and easy fashion.

For instance, in an embodiment, as shown in FIG. 8, video display region 104 may display a “share” button 816 or other user interface element. When a first user interacts with share button 816, media player 406 may generate a link (e.g., a uniform resource locator (URL)) that may be provided to other users by email, text message (e.g., by a tweet), instant message, or other communication medium, as designated by the user (e.g., by providing email addresses, etc.). The generated link include a link/address for video 110, may include a timestamp for a current play time of video 110, and may include search terms and/or other search criteria used by the first user, to be automatically applied to video 110 when a user clicks on the link. When a second user clicks on the link (e.g., on a web page, in an email, etc.), video 110 may be displayed (e.g., in a user interface similar to user interface 102), and may be automatically forwarded to the play time indicated by the timestamp included in the link. Furthermore, transcript 112 may be displayed, with the textual captions of transcript 112 highlighted (as described above) to indicate the search results for the search criteria (e.g., highlighting textual captions that include search terms) applied by the first user.

In further embodiments, additional and/or alternative user interface elements may be present to enable functions to be performed with respect to video 110, transcript 112, and search interface 108. For instance, a user interface element may be present that may be interacted with to automatically generate a “remixed” version of video 110. The remixed version of video 110 may be a shorter version of video 110 that includes portions of video 110 and transcript 112 centered around the search results. For instance, the shorter version of video 110 may include the portions of video 110 and transcript 112 that include the textual captions determined to include search terms.

Furthermore, in embodiments, transcript display module 408 may be configured to automatically add links to text in transcript 112. For instance, transcript display module 408 may include a map that relates links to particular text, may parse transcript 112 for the particular text, and may apply links (e.g., displayed in transcript display region 106 as a clickable hyperlinks) to the particular text. In this manner, users that view transcript 112 may click on links in transcript 112 to be able to view further information that is not included in video 110, but that may enhance the experience of the user. For instance, if speech in video 110 discusses a particular website or other content (e.g., another video, a snippet of computer code, etc.), a link to the content may be shown on the particular text in transcript 112, and the user may be enabled to click on the link to be navigated to the content. Links to help sites and other content may also be provided.

In further embodiments, a group of textual captions may be tagged with metadata to indicate the group of textual captions as a “chapter” to provide increase relevancy for search in textual captions.

One or more videos related to video 110 may be determined by search module 602, and may be displayed adjacent to video 110 (e.g., by title, as thumbnails, etc.). For instance, search module 602 may search a library of videos according to the criteria that the user applied to video 110 for one or more videos that are most relevant to the search criteria, and may display these most relevant videos. Furthermore, other content than videos (e.g., web pages, etc.) that is related to video 110 may be determined by search module 602, and may be displayed adjacent to video 110, in a similar fashion. For instance, search module 602 may include a search engine to which the search terms are applied as search keywords, or may apply the search terms to a remote search engine, to determine the related content.

Still further, the search terms input by users to search interface 108 may be collected, analyzed, and compared with those of other users to provide enhancements. For instance, content hotspots may be determined by analyzing search terms, and these content hotspots may be used to drive additional related content with higher relevance, to select advertisements for display in user interface 102, and/or may be used for further enhancements.

In another embodiment, caption editor 608 may enable a user to annotate one or more textual captions. For instance, in a similar manner as described above with respect to editing textual captions, caption editor 608 may enable a user to add text as metadata to a textual caption as a textual annotation. When the textual caption is shown in transcript display region 106 by transcript display module 408, the textual annotation may be shown associated with the textual caption in transcript display region 106 (e.g., may be displayed next to or below the textual caption, may become visible if a user interacts with the textual caption, etc.).

### III Example Computing Device Embodiments

Transcript generator 202, video searching media player system 314, video searching media player system 402, media player 406, transcript display module 408, search interface module 410, search module 602, caption play time indicator 604, caption location indicator 606, caption editor 608, flowchart 500, flowchart 700, flowchart 900, flowchart 1000, step 1102, and step 1202 may be implemented in hardware, or hardware and any combination of software and/or firmware. For example, transcript generator 202, video searching media player system 314, video searching media player system 402, media player 406, transcript display module 408, search interface module 410, search module 602, caption play time indicator 604, caption location indicator 606, caption editor 608, flowchart 500, flowchart 700, flowchart 900, flowchart 1000, step 1102, and/or step 1202 may be implemented as computer program code configured to be executed in one or more processors and stored in a computer readable storage medium. Alternatively, transcript generator 202, video searching media player system 314, video searching media player system 402, media player 406, transcript display module 408, search interface module 410, search module 602, caption play time indicator 604, caption location indicator 606, caption editor 608, flowchart 500, flowchart 700, flowchart 900, flowchart 1000, step 1102, and/or step 1202 may be implemented as hardware logic/electrical circuitry.

For instance, in an embodiment, one or more of transcript generator 202, video searching media player system 314, video searching media player system 402, media player 406, transcript display module 408, search interface module 410, search module 602, caption play time indicator 604, caption location indicator 606, caption editor 608, flowchart 500, flowchart 700, flowchart 900, flowchart 1000, step 1102, and/or step 1202 may be implemented together in a system-on-chip (SoC). The SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

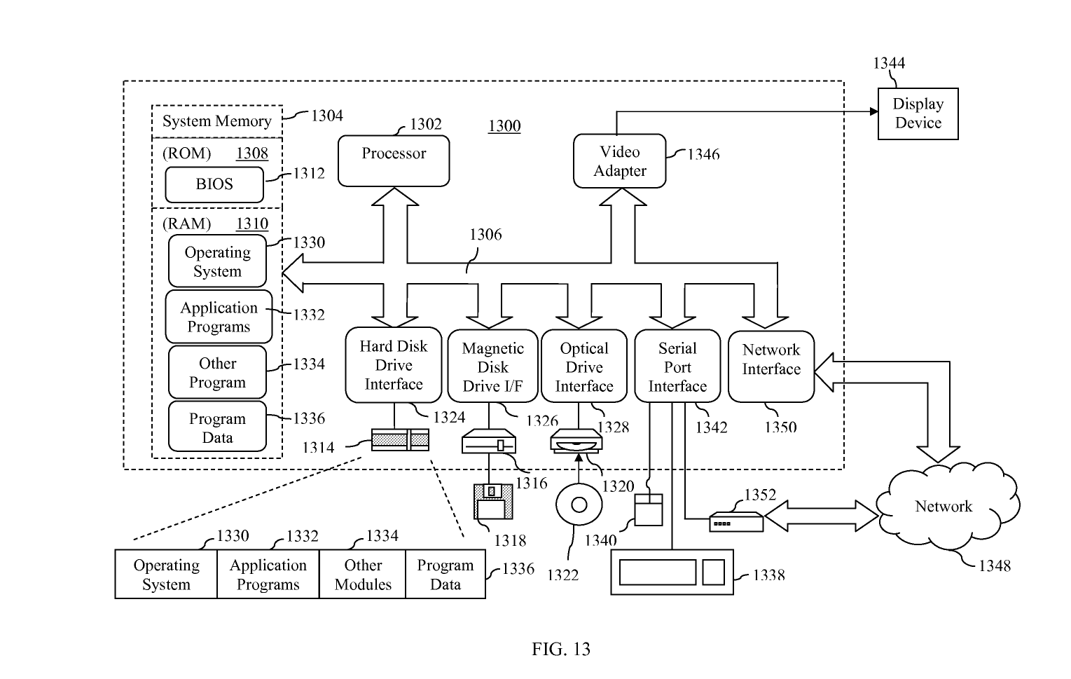

FIG. 13 depicts an exemplary implementation of a computer 1300 in which embodiments of the present invention may be implemented. For example, transcript generation system 200, computing device 302, content server 304, and computing device 400 may each be implemented in one or more computer systems similar to computer 1300, including one or more features of computer 1300 and/or alternative features. Computer 1300 may be a general-purpose computing device in the form of a conventional personal computer, a mobile computer, a server, or a workstation, for example, or computer 1300 may be a special purpose computing device. The description of computer 1300 provided herein is provided for purposes of illustration, and is not intended to be limiting. Embodiments of the present invention may be implemented in further types of computer systems, as would be known to persons skilled in the relevant art(s).

As shown in FIG. 13, computer 1300 includes one or more processors 1302, a system memory 1304, and a bus 1306 that couples various system components including system memory 1304 to processor 1302. Bus 1306 represents one or more of any of several types of bus structures, including a memory bus or memory controller, a peripheral bus, an accelerated graphics port, and a processor or local bus using any of a variety of bus architectures. System memory 1304 includes read only memory (ROM) 1308 and random access memory (RAM) 1310. A basic input/output system 1312 (BIOS) is stored in ROM 1308.

Computer 1300 also has one or more of the following drives: a hard disk drive 1314 for reading from and writing to a hard disk, a magnetic disk drive 1316 for reading from or writing to a removable magnetic disk 1318, and an optical disk drive 1320 for reading from or writing to a removable optical disk 1322 such as a CD ROM, DVD ROM, or other optical media. Hard disk drive 1314, magnetic disk drive 1316, and optical disk drive 1320 are connected to bus 1306 by a hard disk drive interface 1324, a magnetic disk drive interface 1326, and an optical drive interface 1328, respectively. The drives and their associated computer-readable media provide nonvolatile storage of computer-readable instructions, data structures, program modules and other data for the computer. Although a hard disk, a removable magnetic disk and a removable optical disk are described, other types of computer-readable storage media can be used to store data, such as flash memory cards, digital video disks, random access memories (RAMs), read only memories (ROM), and the like.

A number of program modules may be stored on the hard disk, magnetic disk, optical disk, ROM, or RAM. These programs include an operating system 1330, one or more application programs 1332, other program modules 1334, and program data 1336. Application programs 1332 or program modules 1334 may include, for example, computer program logic (e.g., computer program code or instructions) for implementing transcript generator 202, video searching media player system 314, video searching media player system 402, media player 406, transcript display module 408, search interface module 410, search module 602, caption play time indicator 604, caption location indicator 606, caption editor 608, flowchart 500, flowchart 700, flowchart 900, flowchart 1000, step 1102, and/or step 1202 (including any step of flowcharts 500, 700, 900, and 1000), and/or further embodiments described herein.

A user may enter commands and information into the computer 1300 through input devices such as keyboard 1338 and pointing device 1340. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor 1302 through a serial port interface 1342 that is coupled to bus 1306, but may be connected by other interfaces, such as a parallel port, game port, or a universal serial bus (USB).

A display device 1344 is also connected to bus 1306 via an interface, such as a video adapter 1346. In addition to the monitor, computer 1300 may include other peripheral output devices (not shown) such as speakers and printers.

Computer 1300 is connected to a network 1348 (e.g., the Internet) through an adaptor or network interface 1350, a modem 1352, or other means for establishing communications over the network. Modem 1352, which may be internal or external, may be connected to bus 1306 via serial port interface 1342, as shown in FIG. 13, or may be connected to bus 1306 using another interface type, including a parallel interface.

As used herein, the terms “computer program medium,” “computer-readable medium,” and “computer-readable storage medium” are used to generally refer to media such as the hard disk associated with hard disk drive 1314, removable magnetic disk 1318, removable optical disk 1322, as well as other media such as flash memory cards, digital video disks, random access memories (RAMs), read only memories (ROM), and the like. Such computer-readable storage media are distinguished from and non-overlapping with communication media (do not include communication media). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media. Embodiments are also directed to such communication media.

As noted above, computer programs and modules (including application programs 1332 and other program modules 1334) may be stored on the hard disk, magnetic disk, optical disk, ROM, or RAM. Such computer programs may also be received via network interface 1350, serial port interface 1342, or any other interface type. Such computer programs, when executed or loaded by an application, enable computer 1300 to implement features of embodiments of the present invention discussed herein. Accordingly, such computer programs represent controllers of the computer 1300.

The invention is also directed to computer program products comprising software stored on any computer useable medium. Such software, when executed in one or more data processing devices, causes a data processing device(s) to operate as described herein. Embodiments of the present invention employ any computer-useable or computer-readable medium, known now or in the future. Examples of computer-readable mediums include, but are not limited to storage devices such as RAM, hard drives, floppy disks, CD ROMs, DVD ROMs, zip disks, tapes, magnetic storage devices, optical storage devices, MEMs, nanotechnology-based storage devices, and the like.

### VI. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method, comprising:
generating a user interface to display at a computing device, including
generating a video display region of the user interface that displays a video,
generating a transcript display region of the user interface that displays at least a portion of a transcript, the transcript including at least one textual caption of audio associated with the video, and
generating a search interface to display in the user interface that is configured to receive one or more search terms from a user to be applied to the transcript.

2. The method of claim 1, further comprising:
receiving at least one search term provided to the search interface;
determining one or more textual captions of the transcript that include the at least one search term; and
generating one or more indications to display in the transcript display region that indicate the determined one or more textual captions that include the at least one search term.

3. The method of claim 2, wherein said generating a user interface to display at a computing device further comprises:
generating a graphical feature to display in the user interface having a length that corresponds to a time duration of the video; and
generating at least one indication to display at a position on the graphical feature that indicates a time of occurrence of audio corresponding to a textual caption determined to include the at least one search term.

4. The method of claim 2, wherein said generating a user interface to display at a computing device further comprises:
generating a graphical feature to display in the user interface having a length that corresponds to a length of the transcript; and
generating at least one indication to display at a position on the graphical feature that indicates a position of occurrence in the transcript of the textual caption determined to include the at least one search term.

5. The method of claim 1, further comprising:
enabling a user to interact with a textual caption displayed in the transcript display region to provide an edit to text of the textual caption.

6. The method of claim 1, wherein said generating a transcript display region of the user interface that displays at least a portion of a transcript comprises:
generating a user interface element that enables a user to select a language of a plurality of languages for text of the transcript to be displayed in the transcript display region.

7. A system, comprising:
a media player that plays a video in a video display region of a user interface, the video included in a media object that further includes a transcript of audio associated with the video, the transcript including a plurality of textual captions;
a transcript display module that displays at least a portion of the transcript in a transcript display region of the user interface, the displayed at least a portion of the transcript including at least one of the textual captions; and
a search interface module that generates a search interface displayed in the user interface that is configured to receive one or more search terms from a user to be applied to the transcript.

8. The system of claim 7, further comprising:
a search module;
the search interface module receives at least one search term provided to the search interface;
the search module determines one or more textual captions of the transcript that include the at least one search term; and
the transcript display module generates one or more indications to display in the transcript display region that indicate the determined one or more textual captions that include the at least one search term.

9. The system of claim 8, further comprising:
a caption play time indicator that generates a graphical feature displayed in the user interface having a length that corresponds to a time duration of the video; and
the caption indicator displays at least one indication at a position on the graphical feature that indicates a time of occurrence of audio corresponding to a textual caption determined to include the at least one search term.

10. The system of claim 8, further comprising:
a caption location indicator that generates a graphical feature displayed in the user interface having a length that corresponds to a length of the transcript; and
the caption indicator displays at least one indication at a position on the graphical feature that indicates a position of occurrence in the transcript of the textual caption determined to include the at least one search term.

11. The system of claim 8, further comprising:
a caption editor that enables a user to interact with a textual caption displayed in the transcript display region to provide an edit to text of the textual caption.

12. The system of claim 8, further comprising:
a language selector module that generates a user interface element that enables a user to select a language of a plurality of languages for text of the transcript to be displayed in the transcript display region; and
the transcript display module that displays the at least a portion of the transcript in the transcript display region of the user interface in the selected language.

13. A computer readable storage medium having computer program instructions embodied in said computer readable storage medium for enabling a processor to generate a user interface at a computing devices, the computer program instructions comprising:
first computer program instructions that enable the processor to generate a video display region of the user interface that displays a video;
second computer program instructions that enable the processor to generate a transcript display region of the user interface that displays at least a portion of a transcript, the transcript including at least one textual caption of audio associated with the video; and
third computer program instructions that enable the processor to generate a search interface displayed in the user interface that is configured to receive one or more search terms from a user to be applied to the transcript.

14. The computer readable storage medium of claim 13, further comprising:
computer program instructions that enable the processor to receive at least one search term provided to the search interface; and
computer program instructions that enable the processor to determine one or more textual captions of the transcript that include the at least one search term;
wherein said second computer program instructions comprise:
computer program instructions that enable the processor to generate one or more indications to display in the transcript display region that indicate the determined one or more textual captions that include the at least one search term.

15. The computer readable storage medium of claim 14, further comprising:
computer program instructions that enable the processor to generate a graphical feature to display in the user interface having a length that corresponds to a time duration of the video; and
computer program instructions that enable the processor to generate at least one indication to display at a position on the graphical feature that indicates a time of occurrence of audio corresponding to a textual caption determined to include the at least one search term.

16. The computer readable storage medium of claim 14, further comprising:
computer program instructions that enable the processor to generate a graphical feature to display in the user interface having a length that corresponds to a length of the transcript; and
computer program instructions that enable the processor to generate at least one indication to display at a position on the graphical feature that indicates a position of occurrence in the transcript of the textual caption determined to include the at least one search term.

17. The computer readable storage medium of claim 13, further comprising:
computer program instructions that enable the processor to enable a user to interact with a textual caption displayed in the transcript display region to provide an edit to text of the textual caption.

18. The computer readable storage medium of claim 13, wherein second computer program instructions comprises:
computer program instructions that enable the processor to generate a user interface element that enables a user to select a language of a plurality of languages for text of the transcript to be displayed in the transcript display region.
